(19) United States
(12) Patent Application Publication
(10) Pub. No.: US 2015/0336443 A1
(43) Pub. Date: Nov. 26, 2015

(54) Heating Assembly

(71) Applicant: Mark Burrup, South Jordan, UT (US)

(72) Inventor: Mark Burrup, South Jordan, UT (US)

(21) Appl. No.: 14/284,555

(22) Filed: May 22, 2014

(51) Int. Cl. B60H 1/00; B60H 1/22

(52) U.S. Cl. CPC B60H 1/00778; B60H 1/00878; B60H 1/2218; B60H 1/00985

(57) ABSTRACT

A heating assembly for warming an interior of an unoccupied vehicle includes a housing that is positionable within the interior of the vehicle. A processor is coupled to the housing. A heating element is coupled to the housing. The heating element is operationally to the processor. The processor actuates the heating element. The heating element produces heat so the interior of the vehicle is warmed. A transceiver is coupled to the housing. The transceiver is operationally coupled to the processor. The transceiver is in communication with an external electronic device. The external electronic device actuates the processor. A timer is coupled to the housing. The timer is operationally coupled to the processor. The timer actuating the processor after a trigger time has passed.

### BACKGROUND OF THE DISCLOSURE

### Field of the Disclosure

The disclosure relates to heating devices and more particularly pertains to a new heating device for warming an interior of an unoccupied vehicle.

### SUMMARY OF THE DISCLOSURE

An embodiment of the disclosure meets the needs presented above by generally comprising a housing that is positionable within an interior of a vehicle. A processor is coupled to the housing. A heating element is coupled to the housing. The heating element is operationally to the processor. The processor actuates the heating element. The heating element produces heat so the interior of the vehicle is warmed. A transceiver is coupled to the housing. The transceiver is operationally coupled to the processor. The transceiver is in communication with an external electronic device. The external electronic device actuates the processor. A timer is coupled to the housing. The timer is operationally coupled to the processor. The timer actuating the processor after a trigger time has passed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a heating assembly according to an embodiment of the disclosure.

FIG. 2 is a back view of an embodiment of the disclosure.

FIG. 3 is a front view of an embodiment of the disclosure.

FIG. 4 is an in-use view of an embodiment of the disclosure.

FIG. 5 is a schematic view of an embodiment of the disclosure.

### DESCRIPTION OF THE PREFERRED EMBODIMENT

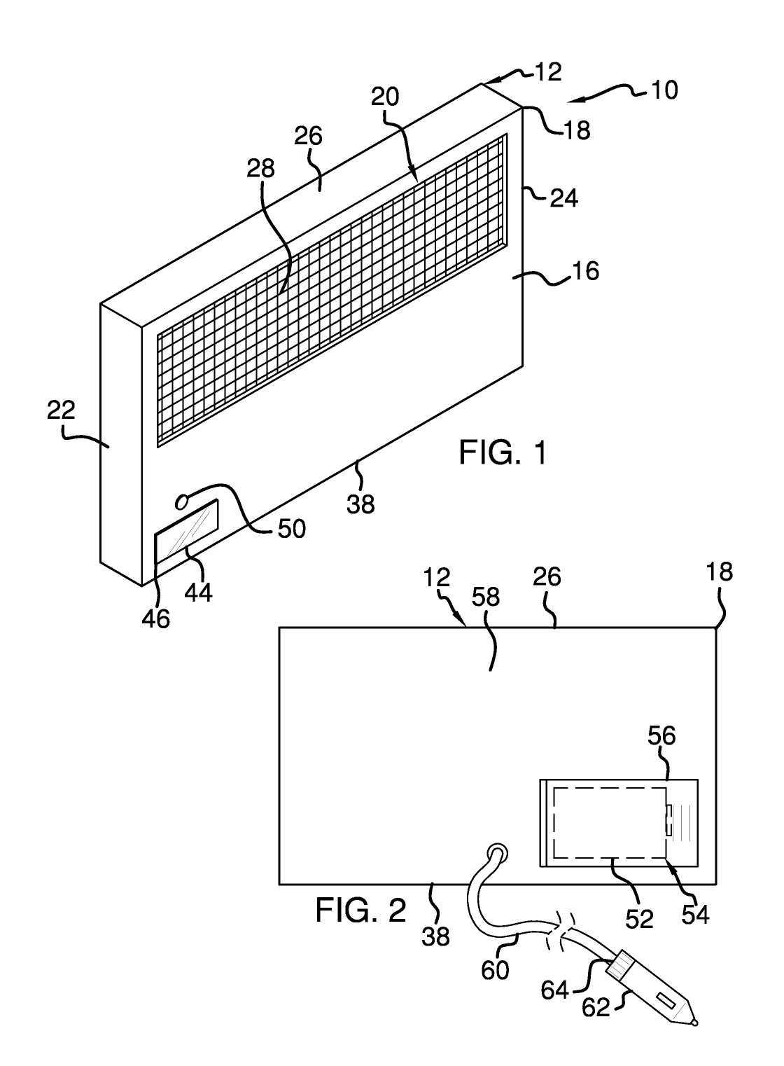

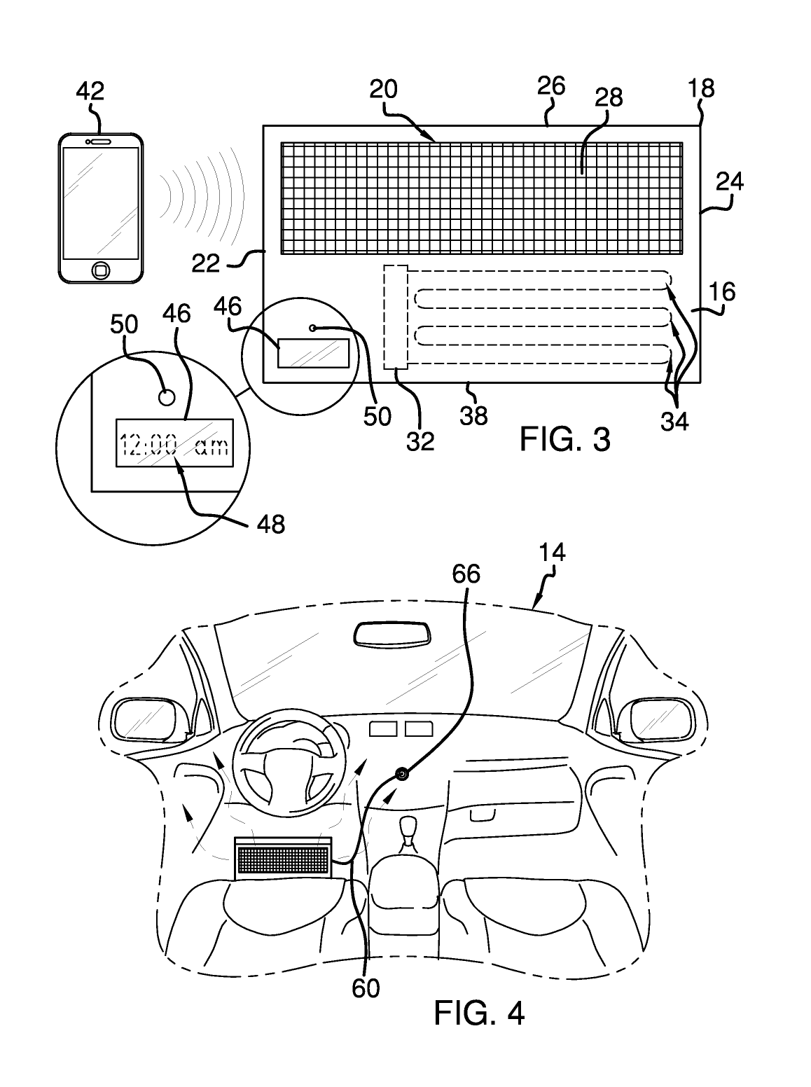

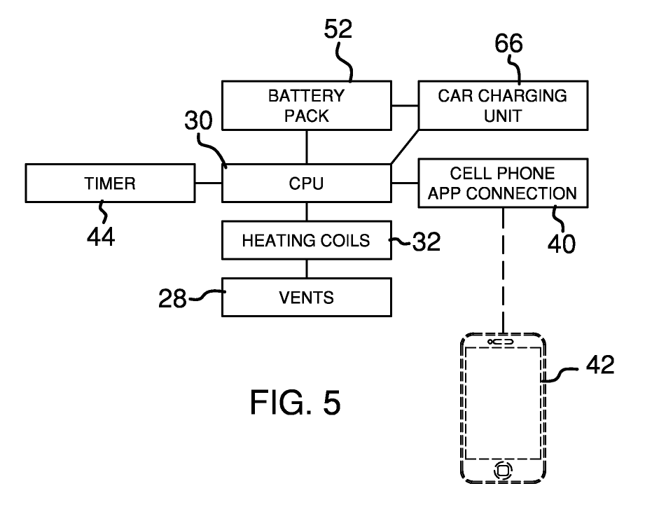

With reference now to the drawings, and in particular to FIGS. 1 through 5 thereof, a new heating device embodying the principles and concepts of an embodiment of the disclosure and generally designated by the reference numeral 10 will be described.

As best illustrated in FIGS. 1 through 5, the heating assembly 10 generally comprises a housing 12 that is positionable within the interior of a vehicle 14. The vehicle 14 may be a passenger vehicle of any conventional design. A top side 16 of an outer wall 18 of the housing 12 has an opening 20 extending therethrough. The opening 20 extends between a first lateral side 22 and a second lateral side 24 of the outer wall 18 of the housing 12 and the opening 20 is positioned adjacent to a front side 26 of the outer wall 18 of the housing 12. A vent 28 is coupled to the top side 16 of the outer wall 18 of the housing 12. The vent 28 completely covers the opening 20.

A processor 30 is coupled to the housing 12. The processor 30 may be an electronic processor of any conventional design. A heating element 32 is coupled to the housing 12. The heating element 32 is positioned within an interior of the housing 12. The heating element 32 comprises a plurality of coils 34 that is evenly spaced apart and distributed between a bottom edge 36 of the opening 20 and a back side 38 of the outer wall 18 of the housing 12.

The heating element 32 is electrically coupled to the processor 30. Moreover, the processor 30 actuates the heating element 32. The heating element 32 produces heat so the interior of the vehicle 14 is warmed. The heat from the heating element 32 escapes the housing 12 through the opening 20. The heating element 32 may be an electric heating element of any conventional design. Additionally, the heating element 32 may have an operational temperature ranging between 60° Fahrenheit and 80° Fahrenheit.

A transceiver 40 is coupled to the housing 12. The transceiver 40 is electrically coupled to the processor 30. The transceiver 40 is in electromagnetic communication with an external electronic device 42. The external electronic device 42 actuates the processor 30. The transceiver 40 may be an RF transceiver of any conventional design. Additionally, the external electronic 42 device may be a Smart Phone of any conventional design.

A timer 44 is coupled to the housing 12. The timer 44 is electrically coupled to the processor 30. The timer 44 comprises a display 46 coupled to the top side 16 of the outer wall 18 of the housing 12. The display 46 is positioned proximate an intersection of the first lateral side 22 and the back side 38 of the outer wall 18 of the housing 12.

The display 46 displays indicia 48. The indicia 48 comprise numbers relating to a time of day. Additionally, the timer 44 actuates the processor 30 after a trigger time of day has passed. The display 46 may be an LCD display of any conventional design.

An actuator 50 is coupled to the top side 16 of the outer wall 18 of the housing 12. The actuator 50 is positioned proximate the display 46. Additionally, the actuator 50 is electrically coupled to the timer 44. The actuator 50 is actuated to set the time of day and to select the trigger time of day.

A power supply 52 is coupled to the housing 12. The power supply 52 is electrically coupled to the processor 30. Moreover, the power supply 52 comprises at least one rechargeable battery 54. A battery cover 56 is removably coupled to a bottom side 58 of the outer wall 18 of the housing 12. The power supply 52 is positioned beneath the battery cover 56.

A charge cord 60 is coupled to and extends away from the bottom side 58 of the outer wall 18 of the housing 12. The charge cord 60 is electrically coupled to the power supply 52. A charge plug 62 is electrically coupled to a free end 64 of the charge cord 60. The charge plug 62 is selectively electrically coupled to a power port 66 in the vehicle 14. The charge cord 60 recharges the power supply 52.

In use, the housing 12 is positioned within the interior of the vehicle 14 when the vehicle 14 is parked in a cold environment. The trigger time of day is selected to actuate the heating element 32. Additionally, the external electronic device 42 is used to actuate or de-actuate the heating element 32. The external electronic device 42 overrides the trigger time of day. The assembly 10 warms the interior of the vehicle 14 so the interior of the vehicle 14 is maintained at a comfortable temperature.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A heating assembly configured to warm an interior of an unoccupied vehicle, said assembly comprising:
a housing positionable within the interior of the vehicle;
a processor coupled to said housing;
a heating element coupled to said housing, said heating element being operationally to said processor such that said processor actuates said heating element, said heating element producing heat such that the interior of the vehicle is warmed;
a transceiver coupled to said housing, said transceiver being operationally coupled to said processor, said transceiver being in communication with an external electronic device such that the external electronic device actuates said processor; and
a timer coupled to said housing, said timer being operationally coupled to said processor, said timer actuating said processor after a trigger time has passed.

2. The assembly according to claim 1, further comprising a top side of an outer wall of said housing having an opening extending therethrough, said opening extending between a first lateral side and a second lateral side of said outer wall of said housing.

3. The assembly according to claim 1, further comprising a vent coupled to a top side of an outer wall of said housing such that said vent completely covers an opening.

4. The assembly according to claim 1, further comprising said heating element being positioned within an interior of said housing, said heating element comprising a plurality of coils being evenly spaced apart and distributed between a bottom edge of an opening and a back side of an outer wall of said housing.

5. The assembly according to claim 1, further comprising said heating element being electrically coupled to said processor.

6. The assembly according to claim 1, further comprising said transceiver being electrically coupled to said processor.

7. The assembly according to claim 1, further comprising said transceiver being in electromagnetic communication with the external electronic device.

8. The assembly according to claim 1, further comprising said timer being electrically coupled to said processor.

9. The assembly according to claim 1, further comprising said timer comprising a display coupled to a top side of an outer wall of said housing, said display being positioned proximate an intersection of a first lateral side and a back side of said outer wall of said housing.

10. The assembly according to claim 9, further comprising said display displaying indicia, said indicia comprising numbers relating to a time of day.

11. The assembly according to claim 1, further comprising a power supply coupled to said housing.

12. The assembly according to claim 11, further comprising said power supply being electrically coupled to said processor.

13. The assembly according to claim 1, further comprising said power supply comprising at least one battery.

14. A heating assembly configured to warm an interior of an unoccupied vehicle, said assembly comprising:
a housing positionable within the interior of the vehicle, a top side of an outer wall of said housing having an opening extending therethrough, said opening extending between a first lateral side and a second lateral side of said outer wall of said housing;
a vent coupled to said top side of said outer wall of said housing such that said vent completely covers said opening;
a processor coupled to said housing;
a heating element coupled to said housing such that said heating element is positioned within an interior of said housing, said heating element comprising a plurality of coils being evenly spaced apart and distributed between a bottom edge of an opening and a back side of an outer wall of said housing, said heating element being electrically coupled to said processor such that said processor actuates said heating element, said heating element producing heat such that the interior of the vehicle is warmed;
a transceiver coupled to said housing, said transceiver being electrically coupled to said processor, said transceiver being in electromagnetic communication with an external electronic device such that the external electronic device actuates said processor;
a timer coupled to said housing, said timer being electrically coupled to said processor, said timer comprising a display coupled to said top side of said outer wall of said housing, said display being positioned proximate an intersection of said first lateral side and said back side of said outer wall of said housing, said display displaying indicia, said indicia comprising numbers relating to a time of day, said timer actuating said processor after a trigger time of day has passed; and
a power supply coupled to said housing, said power supply being electrically coupled to said processor, said power supply comprising at least one battery.
